(19) United States
(12) Patent Application Publication
(10) Pub. No.: US 2014/0252848 A1
(43) Pub. Date: Sep. 11, 2014

(54) UNIVERSAL POWER SUPPLY SYSTEM WITH LOAD ISOLATING AND VOLTAGE ENHANCE DEVICE

(71) Applicants: Rajendra Babu Arumugam, (US); Karthigeyan Rajendrababu, Chennai (IN); Sudharsan Rajendra Buba, Chennai (IN)

(72) Inventor: Rajendra Babu Arumugam, Chennai (IN)

(21) Appl. No.: 14/349,337

(22) PCT Filed: Oct. 3, 2012
(86) PCT No.: PCT/IN2012/000660

§ 371 Date: Apr. 3, 2014

(30) Foreign Application Priority Data
Oct. 3, 2011 (IN) 3416/CHE/2011

(51) Int. Cl. H02J 7/00

(52) U.S. Cl. CPC H02J 7/0068
USPC 307/9.1; 307/64

(57) ABSTRACT

This invention relates to power supply system having recharging unit with load isolation and its method of operation. The power supply unit has one or more energy storage device and such energy storage device is of low voltage rating when compared with the operating voltage of the load. The power supply units when operated through an intermediate section and an output combiner, due to alternative parallel and series connections of capacitors supplies to the load an enhanced voltage as required by the load with complete isolation between the recharging unit of the system and load. The recharging unit supplies the recharging voltage to the input battery whenever the input battery is isolated from the load. Due to which, the energy storage devices serves for large distance range and better speed range in case of electric vehicles.

### FIELD OF INVENTION

This invention relates to a modified electrical power supply system with recharging unit/ recycling unit with complete isolation between source and the load.

This invention is utilized as a power supply in any device or system which is operated electrically. The invention is also suitable for DC or AC load applications. This invention is more relevant for non-conventional energy generating units and electric vehicle applications. For the purpose of clarity and conciseness, in the following description reference is mainly with respect to an electric vehicle with wind generators as the recharging unit. This is without any limitation to the scope of the invention.

### BACKGROUND OF THE INVENTION

The electric vehicles suffer from drawbacks of speed and distance range limitations. To obtain better speed performance and mileage, the voltage and energy capacity of the batteries are important. In order to achieve higher speed and more mileage, large battery packs are adopted as power source, but this leads to disadvantages like high cost of batteries and large space requirements for battery stacking and also increase in the overall weight of the vehicle.

Other techniques followed for improving the distance range of the electric vehicle includes recharging the depleted battery packs by making use of the regenerative energy of the vehicle, utilizing solar energy panels and bulky wind driven generator units with one or more turbines located in wind tunnel or combinations of the above methods. The recharging power obtained from using the regenerative energy is not adequate to make up the loss in the batteries utilized for driving the load. Similarly, the use of large solar energy panels and bulky wind generators in wind tunnel systems always proved to be not feasible because more recharging power is required by the large battery packs and more space requirements for installation of the above systems.

These techniques employing the above methods were followed for recharging the batteries during the vehicle movement to refill battery energy spent in driving the load. While carrying out the recharging of the batteries during movement of the vehicle, the load like drive motor creates an impact on the output of the recharging unit like wind generators thereby affecting the online charging of the batteries. It is quite difficult to charge a battery at the same moment it is discharging to a load as the recharger unit is directly affected by the load. This has led to the problems in real-time charging of the battery packs to achieve the desired distance range.

The drawbacks in an electric vehicle includes speed and distance limitations, usage of large battery packs occupies more space and increases weight of the vehicle, usage of large solar panels and/or bulky wind generators for recharging of the batteries, problems in real-time recharging of the batteries due to impact of the load on the recharging unit during simultaneous charging and discharging. The inventor of this invention has attempted to solve the drawback of distance limitation and problems in real time charging in his earlier Indian application number—2965/CHE/2009; however with a power supply system which includes more than one power supply unit. In case of the two wheeler vehicle in the above application, two power supply units are employed. Each power supply unit has a battery or plurality of batteries connected in series/parallel or in combinations, depending on the required speed and distance range of the vehicle. The load is connected to the output of the power supply unit through an Intermediate section and an output combiner. The system is designed in such a way that the load requirement is shared among the power supply units. While Power Supply 1 is connected to load, the batteries in it are connected in series configuration by the intermediate section in order to obtain the required voltage output and Power Supply 2 is connected to the recharging unit with the batteries in it are connected in parallel configuration by the intermediate section to aid recharging of the batteries and vice versa connection takes place.

The battery used in the power supply units in the above system is either a single battery with the full load voltage or a plurality of batteries suitably connected (series and/or parallel connections) to yield the full load voltage. Usually, the electric vehicle requires a higher load voltage to satisfy the variable speed requirements. Higher load voltage for the electric vehicle leads to the requirement of single large sized battery or multiple batteries connected together in series to arrive at the load voltage. This requirement leads to drawback of more space requirement and also increase in weight and cost of the system/vehicle. Further, the wind generators in the recharging unit should run at higher rpm and the large solar panels are required to yield the required recharging voltage by the large battery packs having batteries in series. Hence, there is a need for a power supply system which overcomes the above drawbacks.

### DESCRIPTION OF THE INVENTION

The main objective of the invention is to develop a power supply system which utilizes a low input voltage from a power supply unit to yield an higher output voltage by maintaining the energy rating of the storage device as well as achieve complete isolation between the load and input power supply unit thereby reducing the burden on the recharging unit and also provide the scope for reutilizing the output power. Specifically in case of an electric vehicle, the objective of the invention is to enhance the distance range with comparatively simpler construction, to achieve the required output voltage with minimum number of batteries for desired speed of the vehicle and maintain Ah rating of the batteries as well as enable uniform operation recharging system or recharging circuit with complete isolation of the battery recharging system from the drive load of the vehicle.

Consider an example of an electric vehicle using 4 nos. of 12V, 100 Ah batteries as input source. In order to achieve higher input voltage for improving speed, the batteries are connected in series and 48 Volts, 100 Ah is obtained. To achieve higher Ampere hours rating for improving mileage, the batteries are connected in parallel and 12 Volts, 400 Ah is obtained. The above configuration gives either higher voltage or higher Ah capacity. It is always desirable to obtain both high voltage and high Ah capacity together to achieve speed and mileage requirements. It is much more desirable to achieve the same using limited number of batteries. By using batteries 4 nos. of 12 V, 100 Ah connected in parallel having total capacity of 12 Volts, 400 Ah as input, it is possible to obtain an output of 48 volts, 400 Ah in the power supply system of this invention. Due to losses in the different stages of the system, the Ah rating may be slightly reduced. This is achieved in this invention.

In the present invention of a modified power supply system in which more than one power supply units are replaced with a single power supply unit having an energy storage device (e.g.) battery. The power supply unit of the present invention includes a single battery having a required Ah rating or a plurality of batteries connected parallel to achieve the required Ah rating. A plurality of batteries connected in parallel are mainly used so that the Ah rating of the parallel combination increases. The voltage rating of the input battery is selected to be less when compared to the load voltage required. The power supply unit with set of batteries in parallel is designed such as to give an output of increased voltage based on the input voltage and the Ah value of the parallel combination remains constant. The power supply unit has plurality of condensers/capacitors suitably connected with the battery and the intermediate section to achieve the required increased output. The intermediate section is the device specifically designed with number of contact members on a single or multiple shafts rotated by motor. Each contact member has atleast one portion to which atleast one positive and/or atleast one negative terminals are connected. The portions and hence terminals are insulated from each other with suitable insulating material. The contact members are separated by gaps or with insulator. The number of contact members is varied based on the load voltage requirements. Series and/or parallel connections of the capacitors can be achieved by rotation of the contact members. This intermediate section can be implemented in the form of an electronic unit as well using microcontroller, timing circuits and switches.

The plurality of capacitors are categorized as input capacitors that are connected at input stage of the intermediate section to receive the input voltage in the intermediate section, transit capacitors that are connected at transit stage of the intermediate section to transit the input voltage from the input stage to the output stage and output capacitors at the output stage accumulates the voltage from the transit stage and supply the multiplied voltage to the load section. The input battery or plurality of batteries connected in parallel along with the input capacitors is the input voltage source. The battery in the power supply units are integrated with a suitable set of condensers and are formed as an accumulator unit. The operation of the condensers in the accumulator unit is such that the condensers receive the floating voltage that is available after the full charging of the battery by the wind generator units. This prevents the battery from depleting faster. Another accumulator unit is used as an output combiner to combine the output voltages of the capacitors from the intermediate section. The load derives the supply from the combiner.

For the sake of clarity and conciseness, let us consider the example of a power supply system in an electric vehicle and batteries as the energy storage devices in the following description. But other types of storage devices like fuel cell, etc. is also feasible. In case of an electric vehicle, the distance covered per unit charge decides the current storage capacity of the input battery and the maximum speed limit to which the vehicle could be accelerated decides the voltage rating of the power supply unit. Hence, a single input battery in the power supply unit is with full load current capacity and minimum voltage rating. Due to minimum voltage rating of the battery, its size becomes small. The weight of the battery and the space occupied by it is very much lowered. This in turn reduces the overall weight of the vehicle which indirectly leads to energy saving and improved mileage. Based on the output voltage required to drive the load at its maximum speed, the minimum voltage of the input battery is increased by the capacitor arrangement and the intermediate section and the increased voltage is supplied to the load. The electric vehicle includes of routine components like drive motor, motor speed controller, gear and brake mechanism, acceleration means.

With this system, it is possible to use a single battery whose voltage is less than the voltage required by the load as an input battery. The said voltage of the input battery is increased in the above system to obtain the operating voltage of the load. Usage of a single battery with voltage rating less than operating voltage of the load enables easy supply of recharging voltage by the recharging unit and the design of the recharging unit becomes simpler. The replacement of the depleted battery using modular plug and socket arrangement further aids easy replacement of the worn out batteries.

The recharging unit is used synonymous to the wind generator (s)/solar panel or any other green energy generators, the charging unit and the recycling circuit throughout this specification.

In one embodiment of the invention, the power supply system comprises of single power supply unit having a single battery of voltage rating less than the load voltage and full load current rating designed as an accumulator unit, an intermediate section with plurality of contact members; each contact member has conducting portions to which atleast one positive and/or atleast one negative terminal of the capacitors are connected to it, plurality of capacitors connected suitably at the input stage, transit stage and output stage of the intermediate section, an output combiner to receive the output voltage for supplying to the load, voltage regulator and at least one recharging unit wherein during first half cycle of rotation of the intermediate section, the input capacitors at the input stage parallel to the input battery are charged to the battery voltage; the transit capacitors at the transit stage are connected parallel to the input capacitors through the intermediate section so that the each of the transit capacitors are charged to the input battery voltage whereas the output capacitors are isolated from the input and transit stage and during the second half cycle of rotation, the transit capacitors are connected to each of the serially connected output capacitors through the intermediate section so that each of the output capacitors are charged to the input battery voltage whereas the input capacitors are isolated from the transit and output stage; the output capacitors are series connected to accumulate the voltage and supply the stepped up voltage to the load through the output combiner; the recharging unit is isolated from the load permanently wherein an output voltage yielded by the series connection of the output capacitors at the output of the intermediate section is equal to the product of input voltage and the number of contact member pairs in the intermediate section with complete isolation between the input battery and load and the recharging unit is connected to the intermediate section such that the said unit supplies power to recharge the depleted input voltage source whenever the said input battery and/or input capacitors are isolated from the transit capacitors. The recharging of the input battery, optionally, is also carried out using the mains power from electricity suppliers. In such case, the mains power is stepped down to the required recharging voltage and is connected as above to recharge the input battery through the intermediate section.

In case a single battery with full load Ah requirement is not feasible, another embodiment of the power supply system shall comprise of single power supply unit having plurality of batteries, designed as accumulator unit, connected in parallel. The said batteries are of minimum voltage and minimum Ah rating, but are connected in parallel to satisfy the full load current requirement. The other constructional features and functions of the power supply system remain the same as first embodiment.

In case of vehicle movement in a traffic congested area, there is provided an option for running the vehicle without engaging the recharging unit. This leads to third embodiment of the invention, in which the power supply system without the recharging unit is employed. The other constructional features and functions of the power supply system remains the same as anyone of the above embodiments.

Another important embodiment of the invention is a power supply system with a single battery or plurality of batteries in parallel as an input battery, having a recycling circuit which recycles the output power to top up the input source. The intermediate section is such that input stage and the output stage are completely isolated which makes the recycling possible. The recycling circuit utilizes either a portion of the output power from the power supply unit before feeding the load or the power regenerated from the load. The recycling circuit includes suitable charger circuit and/or regenerative unit based on the type of load and energy storage device. In this circuit, the input battery supply is used as a starting input and the input battery can be isolated from the system subsequently when the recycling voltage is available at the input voltage source. The recycling circuit takes over and the load voltage is obtained without involving input battery in the system. This embodiment avoids the use of external green energy recharging unit however, the same can be used as a standby or in combination with this embodiment. The rating of the input source is selected such as to take care of the load requirements.

A method of working of a power supply system with a power supply unit having a single battery or a plurality of batteries in parallel to obtain required increased output voltage and a recharging unit with complete isolation from the load comprises the steps of,

a) connecting plurality of capacitors at the input stage, transit stage and output stage of the intermediate section, with atleast one positive terminal and/or atleast one negative terminal of each capacitor to the contact members of the intermediate section suitably,

b) connecting the input capacitors at the input stage in parallel to the input battery unit for charging the input capacitors to full input voltage, and output capacitors in series connection at the output stage to supply cumulative output voltage to the load and at least one recharging unit to a separate contact member of the intermediate section to recharge the input voltage source,

c) operating the intermediate section such that during first half cycle of working of the section, the transit capacitors at the transit stage are connected parallel to the input capacitors through the intermediate section thereby charging each of the transit capacitors to the full input voltage whereas the output capacitors are isolated from the input and transit stage,

d) further operating the intermediate section such that during the second half cycle of working, the transit capacitors are connected to the each of the output capacitors which are connected in series through the intermediate section so that each of the output capacitors are charged to the input battery voltage by the transit capacitors whereas the input capacitors and the input battery which is the input voltage source is isolated from the transit and output stage,

e) supplying the cumulative voltage from the output capacitor in series of the intermediate section to the load through the output combiner

f) operating the recharging unit to top up the depleted input energy of the input voltage source through a separate contact member of the intermediate section
wherein the step (f) is independent of the operation of the power supply unit and the recharging of the input voltage source takes place when there is complete isolation between input stage and transit & output stages,
wherein the transit capacitors are in parallel during charging and in series during discharging alternatively in each cycle of rotation of intermediate section
wherein an output voltage yielded by the series connection of the output capacitors at the output of the intermediate section is equal to the product of input voltage and the number of contact member pairs in the intermediate section.

A method of working of a power supply system having power supply unit with a single-battery or a plurality of batteries in parallel and a recycling unit with complete isolation between the input and output stage comprises the steps of,

a) connecting plurality of capacitors at the input stage, transit stage and output stage of the intermediate section, with atleast one positive terminal and/or atleast one negative terminal of each capacitor to the contact members suitably

b) connecting input capacitors at the input stage in parallel to the input accumulator unit for charging each of the input capacitors to full input battery voltage, and output capacitors in series connection at the output stage to supply cumulative output voltage to the load and at least one recycling circuit to the intermediate section,

c) operating the intermediate section such that during first half cycle of working of the section, the transit capacitors at the transit stage are connected parallel to the input capacitors through the intermediate section thereby charging each of the transit capacitors to the full input voltage whereas the output capacitors are isolated from the input and transit stage,

d) further operating the intermediate section such that during the second half cycle of working, the transit capacitors are connected to the each of the output capacitors which are connected in series through the intermediate section so that each of the output capacitors are charged to the input battery voltage by the transit capacitors whereas the input capacitors and the input battery are isolated from the transit and output stage,

e) Supplying the cumulative voltage from the series connection of output capacitors of the intermediate section to the load through the output combiner,

f) Operating the recycling circuit through a separate contact member of the intermediate section to recharge the depleted input voltage source with the recycling power derived from the output of the combiner,
Wherein the transit capacitors are in parallel during charging and in series during discharging alternatively in each cycle of rotation of intermediate section,
wherein an output voltage yielded by the series connection of the output capacitors at the output of the intermediate section is equal to the product of input voltage and the number of contact member pairs in the intermediate section,
Wherein the input battery is isolated from input capacitors and the recycling unit takes over.

It is noteworthy that this power supply system finds its application in any electrical system or equipment as a power supply source as it utilizes an energy storage device of low voltage rating for powering a load of higher voltage rating and also provides the scope for utilizing the renewable energy and/or reutilizing the output energy.

### BRIEF DESCRIPTION OF THE DRAWINGS

FIG. 1a, represents an electric power supply system with recycling circuit showing first half cycle of rotation of the intermediate section

FIG. 1b, represents an electric power supply system with recycling circuit showing second half cycle of rotation of the intermediate section

FIG. 2, represents an electric power supply system with recharging unit

FIG. 3, represents an enlarged view of contact member pair of the intermediate section of the electric power supply system of FIG. 1a.

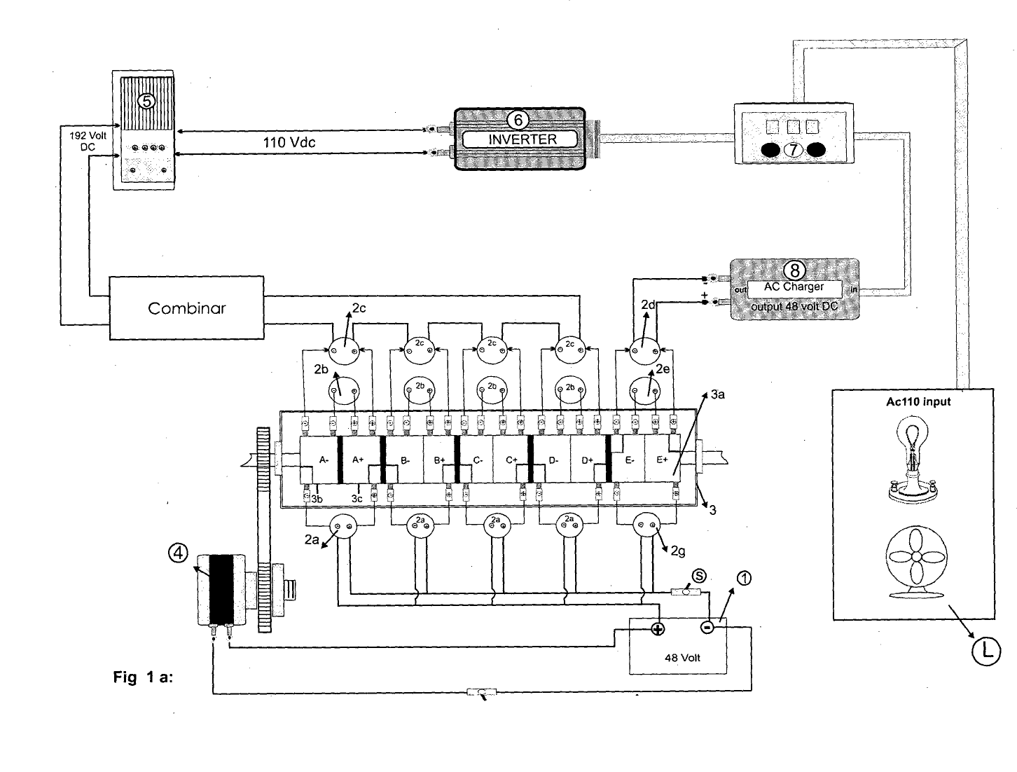

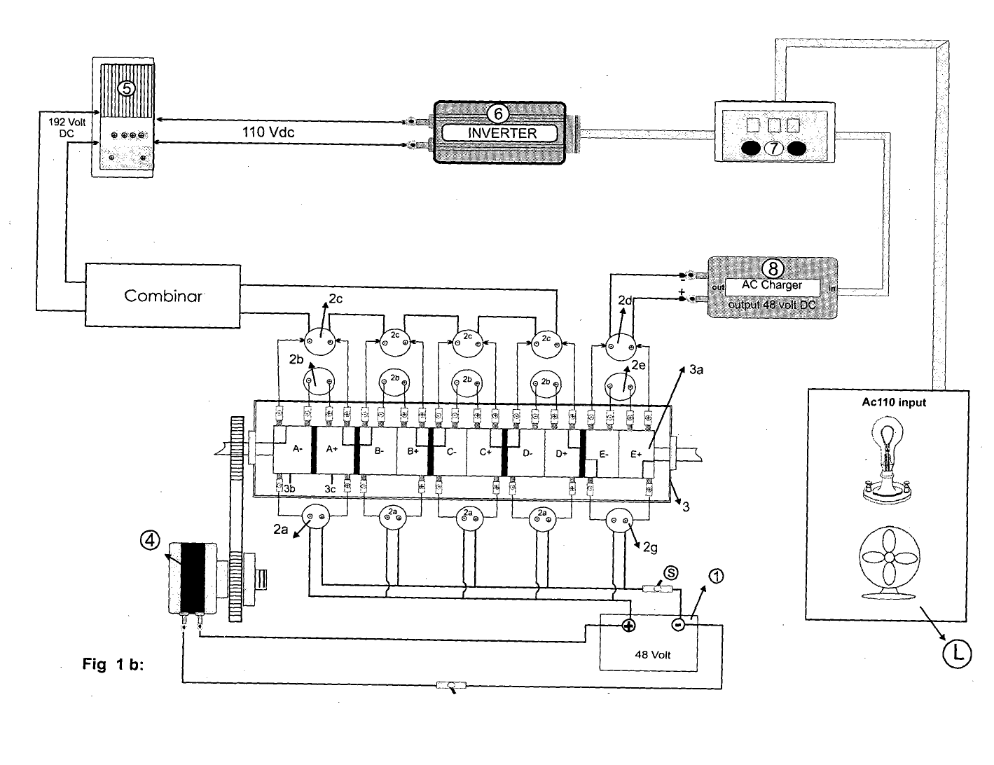

In FIG. 1a, the power supply system comprises of a single power supply unit (1). The power supply unit includes a single battery of specified voltage and Ah rating. The required Ah rating depends on the load requirements. The voltage rating of the single battery is based on the required final output voltage, no. of contact member pairs of the intermediate section (3), weight constraints on the power supply unit, voltage that will be available from the recharging source. A single battery in the power supply unit is replaced by parallel set of batteries if the designing of a single battery with high Ah value is not feasible and if the Ah requirement for the load is more.

For the sake of convenience, a single battery of voltage rating ‘V’ and ampere-hour capacity ‘I’ is considered throughout this description. A plurality of condensers/capacitors (2a, 2b, 2c, 2d, 2e, 2g) is connected between the input battery (1) and load (L) through the intermediate section (3). These capacitors are classified as input capacitors (2a), transit capacitors (2b) and output capacitors (2c) based on their functionality. The capacitors in the recharging or recycling circuit are 2g, 2e, and 2d at its input, transit and output stage respectively. The intermediate section (3) is a device forming part of the power supply system. This device has contact members (3b, 3c, 3d, etc.) mounted on a shaft; the said shaft is rotated by a motor (4). Each contact member is made of conducting material and has different portions (3b1, 3b2, etc.). All the portions are integrated together with insulating material in between them makes a contact member.

Consider an example of the contact members 3b and 3c wherein the members have two portions each viz., 3b1, 3b2 & 3c1, 3c2. The said portions are all connected to positive terminals and/or negative terminals. The design of the contact members is based on the function to be carried out by the intermediate section. The said portion 3b1 & 3b2 are connected to negative terminals of the capacitors. The portions 3b1 & 3b2 are bound together with an insulator 3b3 in between them. The portions 3b1 & 3b2 are connected to negative terminals of the capacitors 2b, 2c and 2a respectively. Hence, during one half cycle of rotation of the contact members 3b, it can be seen that 3b1 connects the negative terminals of capacitors 2b & 2c and the negative terminal of 2a connected to 3b2 is isolated. In another cycle of rotation of the contact member 3b, it can be seen from FIG. (1b) that the negative terminal of 2a comes in contact with negative terminal of 2b through 3b1 and the negative terminal of 2c comes in contact with 3b2 and becomes isolated. Similarly, the contact member 3c is divided into portions 3c1 and 3c2 with insulator 3c3 in between them. The portions 3c1 and 3c2 are connected to positive terminals of 2a, 2b and 2c. When rotated, the connection of terminals takes place as in 3b. Both 3b and 3c are separated with an insulator 3b c in between them to segregate positive and negative terminals. Based on the functionality and design requirements of the intermediate section, a single contact member can have both positive and negative terminals connected to it suitably separated by insulators. The design parameters of the contact member are decided by the frequency of changeover of the contacts. Any number of terminals can be connected to a single contact member, if required, by appropriately splitting the same into number of portions for accommodating the terminals, if required. The contact members may be of different dimensions based on the requirement and are made of electric current conducting materials. The terminals are connected to the contact members through sliding contact having carbon brushes.

In this example shown in FIG. 1a, the contact members 3b and 3c together forms one pair of contact member of the device. Likewise, the device (3) may have numerous pairs based on the design of the power supply system. All the contact members mounted on single shaft rotates in unison. The terminals are connected to the contact members through sliding contacts, carbon brush. The contact members may be mounted on different shaft and such shafts can be rotated at different speeds based on the requirements. The capacitors in this example as illustrated in FIG. 1a are classified into 3 stages. The input stage capacitors 2a are connected in parallel with the input battery (1). The second stage which is a transit stage has capacitors 2b and the final stage (i.e.) output stage has capacitors 2c. The output stage capacitors 2c connected in series supply output voltage to the load. The capacitors of different stages are connected together at different instances through the contact members of the intermediate section. These capacitors receive and transfer the voltage from input to output while multiplying the voltage at the same instance.

To understand the working of the system, consider an example in FIG. 1a having single input battery (1) with 48 volts, 100 Ah, Four nos. of capacitors in each stage (2a,2b,2c) suitable for an operating voltage of 48 volts, intermediate section (3) with four pairs of contact members, an output combiner, voltage regulator, inverter and load. The contact members are mounted on single shaft. The portions of 3b & 3c, 3b1 and 3c1 are identical and 3b2 and 3c2 are identical and so on. Similarly, the portions in other pairs are designed. The shaft is rotated by motor (4). All the four input capacitors (2a) are connected in parallel to the input battery. The input stage is in parallel connection. Hence, each input capacitor is charged to 48 volts by the single input battery. All the four output capacitors are connected in series with each other. The output stage is in series connection. The voltage regulator (5) is a DC voltage regulator which regulates (180-210) volts of input voltage and gives an output of (110-120) volts.

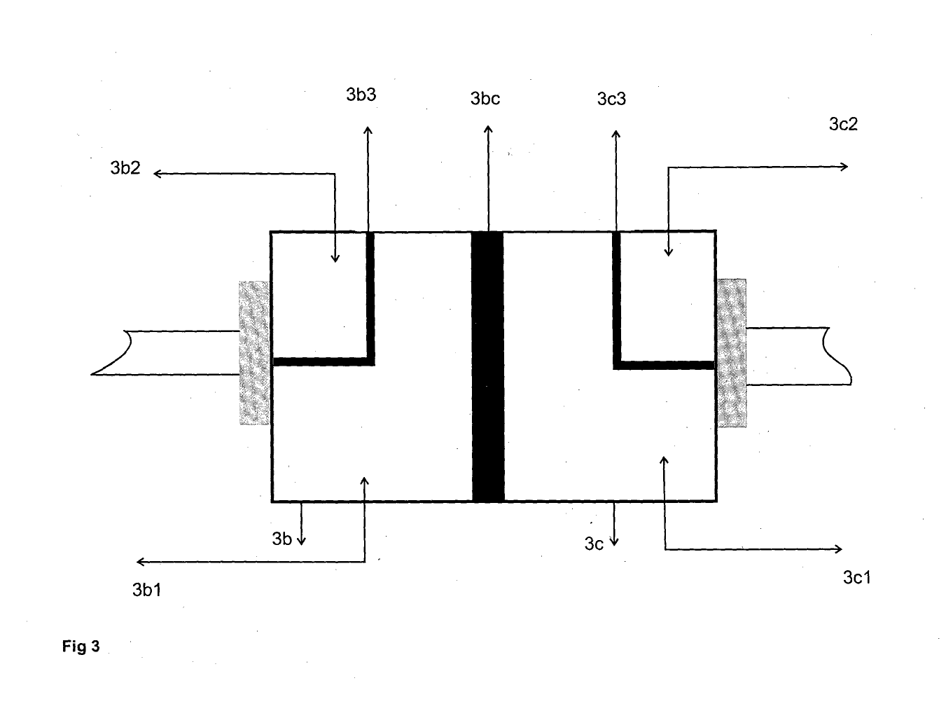

The switch (S) is closed and the input battery (1) charges each of the input capacitors 2a to 48 volts. During first half cycle of rotation of the shaft, as shown in FIG. 1b & FIG. 3, the contact members are rotated such that each of the transit capacitors 2b is connected in parallel to its respective input capacitors 2a with the negative terminal of one of the transit capacitors 2b say 2b1 connects with the negative terminal of one of the input capacitors 2a say 2a1 through the portion 3b1. The negative terminal of one of the output capacitor 2e say 2c1 connects with 3b2 and is isolated from input battery. Similarly, the negative terminal of other three transit capacitors connects with the negative terminal of other input capacitors through the portions of their respective pair. The positive terminals of the transit with input and output capacitors are connected in the same manner as above in adjacent member 3c. Now, each transit capacitors come in parallel connection to each respective input capacitor. Each transit capacitor is now charged individually to 48 volts by the input capacitors. The output capacitors are isolated at this moment.

During second half cycle of rotation of the shaft, each of transit capacitors (2b) comes in connection with each of the respective output capacitors 2c with the negative terminal of one of the transit capacitors 2b say 2b1 connects with the negative terminal of one of the output capacitor 2c say 2c1 through the portion 3b1. The negative terminal of one of the input capacitor 2a say 2a1 connects with 3b2 and hence the input is isolated from the output stage. Similarly, the negative terminal of other three transit capacitors connects with the negative terminal of other output capacitors through the portions of their respective pair. The positive terminal of the transit capacitors connects with output and input capacitors in the same manner as above in adjacent member 3c. Each transit capacitor charged to 48 volts in the first half cycle now discharges it to their respective output capacitor. Each output capacitor of the series connection is now charged individually to 48 volts by the transit capacitors. The transit capacitors are discharged and linked back to input capacitors for charging during the subsequent cycle. The transit capacitors linking to the series connected output stage also becomes serially connected. So, the transit capacitors are connected in parallel to the input stage and are connected in series to the output stage. This alternative parallel and series connection of the transit capacitors takes place during every half cycle of rotation of the intermediate section. Each output capacitor is now charged to 48 volts. So, the serially connected four output capacitors give an output of 192 volts. Hence, 48 volts of a single battery is developed into 192 volts. The input supply and the output to the load are isolated permanently. The frequency of rotation of the intermediate section and frequency of alternative parallel and series connection of the transit capacitors between input stage and output stage is such that there is no disruption and a regular voltage is always available from input stage to the load. It can be noted that the low input voltage is enhanced to a higher output voltage during this operation. Above approximately three rotations per second of the intermediate section, the charging of the transit capacitors while connected in parallel to the input stage and discharging of the transit capacitors while connected in series to the output stage becomes smooth & routine and a continuous voltage is supplied from input to load. This alternative parallel and series connection of the transit capacitors is independent of each other and the possibility of short circuit is nil at any speed of rotation of the intermediate section. The charged output capacitors are serially connected such that an accumulated voltage of 192 volts is available at the input of the voltage regulator. The Ah rating of the input battery remains the same at the output stage. This input of 192 volts is regulated in the voltage regulator to give an output of (110-120) volts.

Even though there is less input voltage say 180 volts or higher input voltage say 210 volts is available to regulator due to improper charging/discharging of the output capacitors 2c, the regulator is designed to given an output of (110-120) volts. This regulated output is inverted to 220 volts AC in an output inverter (6) and is supplied to an AC load (L) through a switch board (7). Thus, an input voltage of 48 volts from a single battery is multiplied and an output voltage of 192 volts is obtained and at the same instance, the isolation between load and input is also maintained through the intermediate section. The output voltage can be further increased by suitably increasing the number of capacitors in each stage and number of contact member pairs in the intermediate section. Hence, this power supply system can yield a higher output voltage from a single battery of low voltage with complete isolation between input and output thereby facilitating the real time recharging of the single battery. In the power supply system with a recharging unit or recycling unit, the input battery is designed as an accumulator unit.

The input capacitors 2a aids in arresting the sparks that occur due to shifting of the terminals frequently. In order to avoid withdrawal of current by the transit capacitors from input battery/input capacitors from output stage all at the same time, the capacitors 2b are not charged at the same time. The contact member are designed such that the transit capacitors 26 connected to different pairs comes in connection with the input capacitors one by one with a time gap and are charged one by one gradually in a sequence by their respective input capacitors (i.e.) 2b1 is charged first by 2a1 followed by 2b2 charged by 2a2 and so on with a time gap to avoid drastic discharge of input battery at the same time. The one by one charging of the transit capacitors is completed before the contact member completes their rotation to establish connection between transit capacitors and output capacitors. Hence, it is clear that the enhanced output voltage is obtained by subsequent charging and discharging of the various set of capacitors connected in parallel and series configurations. This method is totally different from other methods which employ magnetic circuit for stepping up the input voltage in terms of energy loss at various stages and the total isolation between input and load.

This embodiment of the power supply system as shown in FIG. 1a and FIG. 1b is a system added with recycling circuit. This recycling circuit utilizes a certain percentage of the output power to top up the input battery. The intermediate section makes this recycling possible as it discharges the input battery only once during alternative half cycle of rotation and also it maintains complete isolation of input battery and load. In this case, recycling circuit serves as a recharging unit.

In FIG. 1a and FIG. 1b, a separate stage is included in the intermediate section. This stage has contact member 3a which is specifically designed with the conducting portion to aid completion of recycling circuit. The capacitor 2d, 2e and 2g are connected to the contact member. A DC charger (8) in parallel to the load charges the capacitor 2d with the output power. The fully charged capacitor 2d charges the capacitor 2e which in turn once connected to the capacitor 2g through the rotation of the contact member discharges the full voltage to it. The capacitor 2g recharges the input battery. The contact member 3a is designed such that the capacitor 2e connects with capacitor 2g when the transit capacitor 2b connects with output capacitor 2c. At this instant, the input battery is isolated from output stage. This feedback power helps to recharge the depleted battery and this recycling system when clubbed with the recharging system having a wind mill generator, solar energy generator, etc. can be made to recharges the input battery during different cycles of rotation of intermediate section. In this circuit, the input battery supply is used as a starting input and the input battery can be isolated from the system subsequently when the recycling voltage is available at the input voltage source. The recycling circuit takes over and the load voltage is obtained without involving input battery in the system.

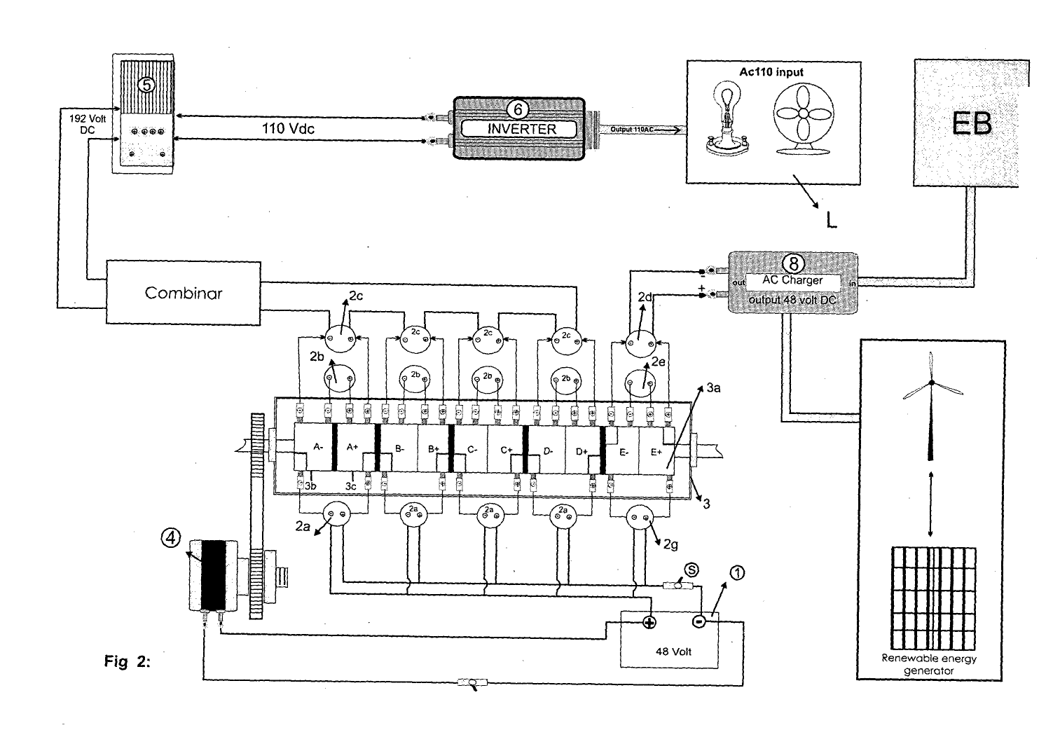

In FIG. 2, a power supply system with a recharging unit having green energy generator unit or a mains power from an electricity supplier is used. The recharging is carried out as described earlier through the separate contact member pair of the intermediate section.

This power supply system if incorporated in an electric vehicle, overcomes the drawbacks in the existing electric vehicles. This power supply system with its high voltage output and the maintained Ah rating gives an improved speed performance and mileage for the electric vehicles. This system also enables smooth recharging of the depleted energy in the input battery using recharging unit or a recycling circuit by isolating the load and input completely. Other implicit benefits are, firstly the usage of a single low voltage battery brings down overall weight of the vehicle to a greater extent. This reduction in body weight adds to increase in mileage. Secondly, with the use of the intermediate section, the input battery is discharged only during alternative half cycle of rotation of the contact member. This discharge occurs only when the transit capacitors are connected in parallel to the input capacitors. This prolongs discharging time of the energy in input battery for the same load thereby increasing the mileage. Further, the incorporation of a recharging unit and/or recycling unit increases the mileage of the vehicle.

The above system proves to be very useful for wind mill applications as well. Due to the usage of the low voltage input source, the recharging of the input source with minimum rotations of the wind mill becomes possible. Further, the speed of rotation of the wind mill blades are not affected by the load due to permanent isolation between the load on the grid and its input source. This power supply system leads to simplification of the wind mill designs. This power supply system also finds application in gensets and in general as a source of power in any electrical system.

The invention has been described with reference to the structure disclosed herein, it is not confined to the details set forth and this application is intended to cover such modification or changes as may come within the purpose of the improvements.

I claim:

1. An electric power supply system comprising a single power supply unit with single input battery, an intermediate section with plurality of contact members: each contact member has conducting portions to which at least one positive and/or at least one negative terminal of the input, transit and output capacitors are connected and at least one separate contact member having conducting portion to which at least one positive and for at least one negative terminal of the capacitors of the recharging units are connected: the said portions are separated with insulation in between; plurality of capacitors suitably connected at the input stage, transit stage and output stage of the intermediate section are connected to the said contact members; an output combiner to receive the output voltage and supply the same to the load through a regulator and an inverter and at least one battery recharging unit
wherein the transit capacitors are connected in parallel and series connections alternatively during each cycle of working of the intermediate section
wherein an output voltage yielded by the series connection of the output capacitors at the output of the intermediate section is equal to the product of input voltage and the number of contact member pairs in the intermediate section with complete isolation between the input battery and load and the recharging unit is connected to the intermediate section such that the said unit supplies power to recharge the depleted input voltage source whenever the said input battery and/or input capacitors are isolated from the transit capacitors.

2. An electric power supply system comprising a single power supply unit with single input battery, an intermediate section having plurality of contact members: each contact member has conducting portions to which at least one positive and/or at least one negative terminal of the input, transit and output capacitors are connected and at least one separate contact member having conducting portion to which at least one positive and for at least one negative terminal of the capacitors of the recycling circuit are connected: the said conducting portions are separated with insulation in between; plurality of capacitors suitably connected to the said contact members at the input stage, transit stage and output stage of the intermediate section; an output combiner to receive the output voltage and supply the same to the load; a regulator; an inverter; an output recycling circuit
wherein the transit capacitors are connected in parallel and series connections alternatively during each cycle of working of the intermediate section
wherein an output voltage yielded by the series connection of the output capacitors at the output stage of the intermediate section is equal to the product of input voltage and the number of contact member pairs of the intermediate section with complete isolation of the input battery from the load and the recycling circuit is connected to the intermediate section such that the said circuit supply part of the output power through charger to recharge the depleted input voltage source whenever the said input battery and/or input capacitors are isolated from the transit capacitors.

3. An electric power supply system as claimed in claim 2 wherein the said input battery supply is utilized as a starting input and the said battery is isolated from the system when the recycling unit takes over.

4. An electric power supply system comprising a single power supply unit with single input battery, an intermediate section with plurality of contact members: each contact member has conducting portions to which at least one positive and/or at least one negative terminal of the input, transit and output capacitors are connected: the said portions are separated with insulation in between; plurality of capacitors suitably connected to the said contact members at the input stage, transit stage and output stage of the intermediate section; an output combiner to receive the output voltage and supply the same to the load through a regulator and an inverter
wherein the transit capacitors are connected in parallel and series connections alternatively during each cycle of working of the intermediate section.
wherein an output voltage yielded from the output of the intermediate section is equal to the product of input voltage and the number of contact member pairs of the intermediate section with complete isolation between the input battery and load.

5. An electric power supply system as claimed in claim 1 wherein the input capacitors at the input stage of intermediate section are parallel to the input battery; the plurality of capacitors at the input stage, transit stage and output stage are suitably connected to the contact members and the said contact members of the intermediate section are designed such that during first half cycle of working of the intermediate section, the transit capacitors at the transit stage are connected parallel to the input capacitors at the input stage and each of the transit capacitors are charged individually to the input battery voltage whereas the output capacitors are isolated from input and transit stage; and during second half cycle of working of the intermediate section, the transit capacitors at the transit stage are connected to the output capacitors which are connected in series at the output stage and each of the output capacitors are individually charged by the transit capacitors to the voltage of the input battery whereas the input capacitors are isolated from transit and output stage, and the said output capacitors in series connection yields a cumulative voltage thereby maintaining a permanent isolation between the load and input and/or the recharging unit or the recycling unit.

6. An electric power supply system as claimed in claim 1 wherein during first half cycle of working, every transit capacitor is charged with the input voltage when connected in parallel to the respective individual input capacitors which are already charged by input battery and during second half cycle of working, every transit capacitor is discharged to supply the input voltage acquired by them to each of the respective individual output capacitors connected in series.

7. An electric power supply system as claimed in claim 1 wherein during one complete cycle of working of the intermediate section, a single input battery voltage is converted into multiple similar voltages in transit capacitors and such multiple voltages are transferred to the output capacitors in which the said multiple voltages are accumulated into a single higher output voltage and such output voltage is equal to the product of number of said similar voltages and the input battery voltage.

8. An electric power supply system as claimed in claim 1, wherein the cumulative voltage is further increased by increasing the number of contact member pairs along with the number of input, transit and output capacitors suitably connected to the contact members.

9. An electric power supply system as claimed in claim 1, wherein the contact members for the input, transit & output capacitors and the contact members for the recharging or recycling unit are mounted on different shafts and such shafts are rotated at different speeds.

10. An electric power supply system as claimed in claim 1 wherein the frequency of shifting of transit capacitors for charging from input capacitors and for discharging to output capacitors is such that a continuous cumulative voltage is supplied from input stage to the load without any disruption.

11. An electric power supply system as claimed in claim 1, wherein the frequency of shifting is at least 3 complete cycles per second.

12. An electric power supply system as claimed in claim 1 wherein the single power supply unit has plurality of parallel connected input batteries.

13. An electric power supply system as claimed in claim 1 wherein the input batteries in the single power supply unit is designed as an accumulator unit.

14. An electric power supply system as claimed in claim 1 wherein the voltage regulator is designed such that to regulate the varying the output voltage and yield a constant voltage required by the load.

15. An electric power supply system as claimed in claim 1 wherein the contact members are designed such that the transit capacitors connected to each pair are charged one after another by the respective input capacitors connected to each pair.

16. An electric power supply system as claimed in claim 1 wherein both the recharging unit and the recycling circuit are incorporated to recharge the depleted input battery during different cycles of the intermediate section.

17. An electric power supply system as claimed in claim 1 wherein the recharging unit is a wind energy generator and/or a solar energy generator.

18. An electric power supply system as claimed in claim 1 wherein the recharging power is obtained from a mains supply of an electricity supplier.

19. An electric power supply system as claimed in claim 1 wherein the number of pairs of the contact member in the intermediate section is based on the required load voltage.

20. An intermediate device as claimed in claim 1 comprises of plurality of contact members mounted on single or plurality of shafts, a motor to rotate the shaft(s) wherein the contact members have plurality of portions to which at least one positive and/or at least one negative terminal of the energy storage device is connected: the different portions to which the said terminals are connected in the contact member are insulated and each contact member is insulated from other contact member.

21. An intermediate device as claimed in claim 20 wherein the contact members are of different dimensions and made of electric current conducting materials.

22. An intermediate device as claimed in claim 20 wherein the said terminals are connected to the contact members through sliding contact having carbon brushes.

23. A method of working of a power supply system with a power supply unit having a single battery or a plurality of batteries in parallel to obtain required increased output voltage and a recharging unit with complete isolation from the load comprises the steps of,
a) connecting plurality of capacitors at the input stage, transit stage and output stage of the intermediate section, with at least one positive terminal and/or at least one negative terminal of each capacitor to the contact members of the intermediate section suitably,
b) connecting the input capacitors at the input stage in parallel to the input battery unit for charging the input capacitors to full input voltage, and output capacitors in series connection at the output stage to supply cumulative output voltage to the load and at least one recharging unit to a separate contact member of the intermediate section to recharge the input voltage source,
c) operating the intermediate section such that during first half cycle of working of the section, the transit capacitors at the transit stage are connected parallel to the input capacitors through the intermediate section thereby charging each of the transit capacitors to the full input voltage whereas the output capacitors are isolated from the input and transit stage,
d) further operating the intermediate section such that during the second half cycle of working, the transit capacitors are connected to the each of the output capacitors which are connected in series through the intermediate section so that each of the output capacitors are charged to the input battery voltage by the transit capacitors whereas the input capacitors and the input battery are isolated from the transit and output stage,
e) Supplying the cumulative voltage from the output capacitor in series of the intermediate section to the load through the output combiner
f) Operating the recharging unit to top up the depleted input energy of the input battery through a separate contact member of the intermediate section.
wherein the step (f) is independent of the operation of the power supply unit and the recharging of the input voltage source takes place when there is complete isolation between input stage and transit & output stages,
wherein the transit capacitors are connected in parallel and series connections alternatively during each cycle of rotation of intermediate section,
Wherein an output voltage yielded by the series connection of the output capacitors at the output of the intermediate section is equal to the product of the input voltage and the number of contact member pairs in the intermediate section.

24. A method of working of a power supply system having power supply unit with a single battery or a plurality of batteries in parallel and a recycling unit with complete isolation between the input and output stage comprises the steps of,
a) Connecting plurality of capacitors at the input stage, transit stage and output stage of the intermediate section, with at least one positive terminal and/or at least one negative terminal of each capacitor to the contact members suitably
b) Connecting the input capacitors at the input stage in parallel to the input accumulator unit for charging each of the input capacitors to full input battery voltage, and output capacitors in series connection at the output stage to supply cumulative output voltage to the load and at least one recharging unit
c) operating the intermediate section such that during first half cycle of working of the section, the transit capacitors at the transit stage are connected parallel to the input capacitors through the intermediate section thereby charging each of the transit capacitors to the full input voltage whereas the output capacitors are isolated from the input and transit stage,
d) further operating the intermediate section such that during the second half cycle of working, the transit capacitors are connected to each of the output capacitors which are connected in series through the intermediate section so that each of the output capacitors are charged to the input battery voltage by the transit capacitors whereas the input capacitors and the input battery are isolated from the transit and output stage,
e) supplying the cumulative voltage from the output capacitor in series of the intermediate section to the load through the output combiner
f) operating the recycling circuit through a separate contact member of the intermediate section to recharge the depleted input voltage source with the recycling power derived from the output of the combiner
wherein the transit capacitors are connected in parallel and series connections alternatively during each cycle of rotation of intermediate section.
wherein an output voltage yielded by the series connection of the output capacitors at the output of the intermediate section is equal to the product of input voltage and the number of contact member pairs in the intermediate section.

25. A method of working of a power supply system as claimed in claim 23 wherein the input battery is isolated from input capacitors and the recycling unit takes over to supply the required input of the system.

26. A method of working of a power supply system as claimed in claim 22 wherein to avoid drastic discharge of the input battery, the portions of the contact members are designed and the intermediate section is operated such that the transit capacitors connected to different contact member pairs are charged one after another in a sequence by the respective input capacitors connected to the said pair.

27. An electric power generating system incorporating the electric power supply system as claimed in claim 1.

28. A vehicle system incorporating the electric power supply system as claimed in claim 1.
